(19) United States
(12) Patent Application Publication
(10) Pub. No.: US 2020/0233425 A1
(43) Pub. Date: Jul. 23, 2020

(54) VEHICLE DRIVING ASSISTANCE SYSTEM AND VEHICLE DRIVING ASSISTANCE METHOD

(71) Applicant: Mazda Motor Corporation, Hiroshima (JP)

(72) Inventor: Hideki TAKAHASHI, Hiroshima (JP)

(73) Assignee: Mazda Motor Corporation, Hiroshima (JP)

(21) Appl. No.: 16/739,147

(22) Filed: Jan. 10, 2020

(30) Foreign Application Priority Data
Jan. 17, 2019 (JP) 2019-005721

(51) Int. Cl. G05D 1/02

(52) U.S. Cl. CPC G05D 1/0217; G05D 1/0214; G05D 2201/0213; G05D 2201/0212; G05D 1/0255

(57) ABSTRACT

A system, method and computer program product provide vehicle driving assistance, wherein candidate travel routes for the vehicle are analyzed to identify one of the travel routes as a selected travel route. The selection includes calculating a route cost associated with vehicle acceleration/deceleration, for each of the candidate routes and selecting the one with the lowest cost.

### CROSS REFERENCE TO RELATED APPLICATIONS

The present application contains subject matter related to Japanese Priority Application 2019-005721, filed in the Japanese Patent Office on Jan. 17, 2019, the entire contents of which being incorporated herein by reference in its entirety. The application also contains subject matter related to that described in U.S. application Ser. No. ______, having attorney docket number 13081US01, and claiming priority to JP 2019-005720; U.S. application Ser. No. ______, having attorney docket number 13089US01, and claiming priority to JP 2019-005722; U.S. application Ser. No. ______, having attorney docket number 13090US01, and claiming priority to JP 2019-005723, the entire contents of each of which being incorporated herein by reference in their entirety.

### TECHNICAL FIELD

The present disclosure relates to a vehicle driving assistance system and a vehicle driving assistance method for setting a travel route for a vehicle and assisting with driving on the basis of this travel route.

### BACKGROUND ART

Conventionally, as travel route generation algorithms for a vehicle, a potential method, a spline interpolation function, an A-star (A*) method, Dijkstra's algorithm, RRT, a state lattice method, and the like are used.

In the A-star method and the Dijkstra's method, grids that are partitioned vertically and horizontally are each set as a node, and the nodes are expanded in a manner to minimize cost (route cost). In this way, a route is searched. For example, in Patent document 1, a route search system that selects a route with the minimum cost among routes from a start point to an end point included in an area represented by the grids is disclosed. In the route search system, the node with the minimum cost is expanded, more specifically, the number of expanding directions from the node with the minimum cost is set according to a moving direction, and the moving direction for the expanded node with the minimum cost is determined.

In the state lattice method, a grid area including a large number of grid points is set in a travel road, these grid points are sequentially connected to set a large number of travel route candidates, and one travel route is selected from these travel route candidates. For example, in Patent document 2, a vehicle driving assistance system is disclosed. In the vehicle driving assistance system, the plural travel routes are set on a grid map, movement cost indicative of a degree of danger in the case where a host vehicle travels is set for each cell of the grid map, and one of the travel routes is selected on the basis of this movement cost.

### PRIOR ART DOCUMENTS

### Patent Documents

[Patent document 1] JP-A-2011-128758

[Patent document 2] WO 2013/051081

### SUMMARY OF THE DISCLOSURE

### Problems to be Solved by the Disclosure

By the way, conventionally, the route cost that is defined according to acceleration/deceleration (meaning acceleration and/or deceleration, and the same applies hereinafter) in a longitudinal direction generated on the vehicle is used to set the travel route. It is considered that this route cost is set to have a higher value as the acceleration/deceleration (an absolute value) is increased. In a typical example, it is considered that, when the acceleration/deceleration is equal to or higher than a specified threshold, the relatively high route cost (a constant value) is uniformly set, so as not to set the travel route on which such acceleration/deceleration is generated.

In the case where the route cost is defined according to the acceleration/deceleration just as described, generally, the travel route on which the acceleration/deceleration is lower than the threshold is preferentially set. However, depending on a case, it is sometimes desirable to set the travel route on which the acceleration/deceleration is equal to or higher than the threshold. For example, a case of setting the travel route to avoid an obstacle is considered. In this case, it is expected that plural candidates for the travel route, on which the acceleration/deceleration is equal to or higher than the threshold, are provided. Thus, the optimum travel route is preferably selected from such plural travel route candidates. Meanwhile, in the method for setting the route cost to the constant value when the acceleration/deceleration is equal to or higher than the threshold as described above, it is difficult to appropriately select the travel route to be applied from the plural travel route candidates, on each of which the acceleration/deceleration is equal to or higher than the threshold.

The present disclosure has been made to solve the above-described and other problems, and therefore has a purpose of providing a vehicle driving assistance system and a vehicle driving assistance method capable of appropriately selecting a travel route on the basis of route cost that is defined according to a magnitude of acceleration/deceleration in the case where a travel route on which the relatively high acceleration/deceleration is generated is set.

### Means for Solving the Problems

In order to achieve the above and other purposes, the present disclosure is a vehicle driving assistance system including:

a travel road information acquisition interface that acquires travel road information about a travel road on which a vehicle is located, the interface configured to obtain the travel road information from any combination of a sensor, a set of sensors, and a remote source; and

a controller having circuitry configured to set a target travel route for the vehicle in the travel road based on the travel road information and to execute driving control of the vehicle so the vehicle travels along the target travel route, wherein

the circuitry is configured to:
set plural travel route candidates as candidate options for setting the target travel route based on the travel road information;
calculate route cost for each of the plural travel route candidates; and
select one travel route of the plural travel route candidates as the target travel route on the basis of having a lowest route cost, and

the circuitry is further configured to:
under a condition where a magnitude of acceleration/deceleration that is generated in a longitudinal direction of vehicle movement on the travel route candidate is lower than a specified threshold, set the route cost to a first specified constant value,

under a condition where the magnitude of the acceleration/deceleration is the specified threshold, set the route cost to a second specified value that is higher than the first specified value, and
under a condition where the magnitude of the acceleration/deceleration exceeds the specified threshold, set the route cost to an aggregate value that is a summation result of a value that increases with the magnitude of the acceleration/deceleration and the second specified value.

In the present disclosure that is configured just as described, the controller (1) sets the route cost to the first specified constant value in the case where the acceleration/deceleration (an absolute value) that is generated in the longitudinal direction at the time when the vehicle travels on the travel route candidate is lower than the threshold, (2) sets the route cost to the second specified value that is higher than the first specified value in the case where the acceleration/deceleration is the threshold, and (3) sets the route cost to the value that is acquired by adding the value increased according to the magnitude of the acceleration/deceleration to the second specified value in the case where the acceleration/deceleration exceeds the threshold. That is, in the present disclosure, in the case where the acceleration/deceleration is equal to or higher than the threshold, the route cost is not set to the constant value regardless of the magnitude of the acceleration/deceleration, but the route cost varies according to the magnitude of the acceleration/deceleration. As a result, the route cost appropriately differs among the plural travel route candidates, on each of which the acceleration/deceleration is equal to or higher than the threshold. Thus, it is possible to select the optimum travel route (typically, of the travel routes, on each of which the acceleration/deceleration is equal to or higher than the threshold, the travel route where the lowest acceleration/deceleration is the lowest) from these plural travel route candidates. Therefore, according to the present disclosure, in the case where the travel route where the relatively high acceleration/deceleration is generated is set, it is possible to select an appropriate travel route on the basis of the route cost that is defined according to the magnitude of the acceleration/deceleration.

In the present disclosure, preferably, the controller is configured to set the route cost by adding a value, which is increased linearly as the acceleration/deceleration is increased, to the second specified value in the case where the magnitude of the acceleration/deceleration exceeds the threshold.

In the present disclosure that is configured just as described, the route cost can reliably differ among the plural travel route candidates, on each of which the acceleration/deceleration is equal to or higher than the threshold.

In the present disclosure, preferably, the threshold is defined on the basis of the magnitude of the acceleration/deceleration that can be accepted by a driver of the vehicle.

In the present disclosure that is configured just as described, the threshold is defined on the basis of the acceleration/deceleration that can be accepted by the driver, and thus setting of the travel route where the acceleration/deceleration that is equal to or higher than this threshold is generated is hindered. In this way, it is possible to suppress the driver from receiving a sense of discomfort caused by the acceleration/deceleration.

In the present disclosure, preferably, the first specified value is 0.

In the present disclosure that is configured just as described, the route cost related to the acceleration/deceleration is not substantially applied to the travel route where the acceleration/deceleration is lower than the threshold. Thus, it is possible to preferentially set the travel route where the acceleration/deceleration is lower than the threshold.

In the present disclosure, preferably, the controller sets plural sampling points on the route of each of the plural travel route candidates, and sets the route cost at each of the sampling points set for each of the plural travel route candidates on the basis of the magnitude of the acceleration/deceleration.

In the present disclosure that is configured just as described, the route cost is calculated for each of the plural sampling points set for each of the travel route candidates. Thus, it is possible to accurately evaluate each of the plural travel route candidates.

In another aspect, in order to achieve the above purpose, the present disclosure is a vehicle driving assistance method that is executed by a controller including a computer and includes: a step of setting plural travel route candidates as candidates for setting a target travel route for a vehicle in a travel road on the basis of travel road information on the travel road of the vehicle; a step of calculating route cost for each of the plural travel route candidates; a step of selecting one travel route of the plural travel route candidates as the target travel route on the basis of the route cost; and a step of executing driving control of the vehicle such that the vehicle travels along the target travel route. In the step of calculating the route cost, the method further: sets the route cost to a first specified constant value in the case where a magnitude of acceleration/deceleration that is generated in a longitudinal direction at the time when the vehicle travels on the travel route candidate is lower than a specified threshold; sets the route cost to a second specified value that is higher than the first specified value in the case where the magnitude of the acceleration/deceleration is the threshold; and sets the route cost to a value that is acquired by adding a value increased according to the magnitude of the acceleration/deceleration to the second specified value in the case where the magnitude of the acceleration/deceleration exceeds the threshold.

Also, in the present disclosure that is configured just as described, in the case where the travel route where the relatively high acceleration/deceleration is generated is set, it is possible to select an appropriate travel route on the basis of the route cost that is defined according to the magnitude of the acceleration/deceleration.

### Advantage of the Disclosure

According to the vehicle driving assistance system and the vehicle driving assistance method in the present disclosure, in the case where the travel route where the relatively high acceleration/deceleration is generated is set, it is possible to select the appropriate travel route on the basis of the route cost that is defined according to the magnitude of the acceleration/deceleration.

### BRIEF DESCRIPTION OF THE DRAWINGS

FIG. 1 is a block diagram illustrating a schematic configuration of a vehicle driving assistance system according to an embodiment of the present disclosure.

FIG. 2 is an explanatory view of basic concept of driving assistance according to the embodiment of the present disclosure.

FIG. 3 is a map defining route cost according to the embodiment of the present disclosure.

FIG. 4 is a flowchart of driving assistance processing according to the embodiment of the present disclosure.

FIG. 5 is a block diagram of a computer-based system on which embodiments of the present system may be implemented.

### MODES FOR CARRYING OUT THE DISCLOSURE

A description will hereinafter be made on a vehicle driving assistance system and a vehicle driving assistance method according to an embodiment of the present disclosure with reference to the accompanying drawings.

[System Configuration]

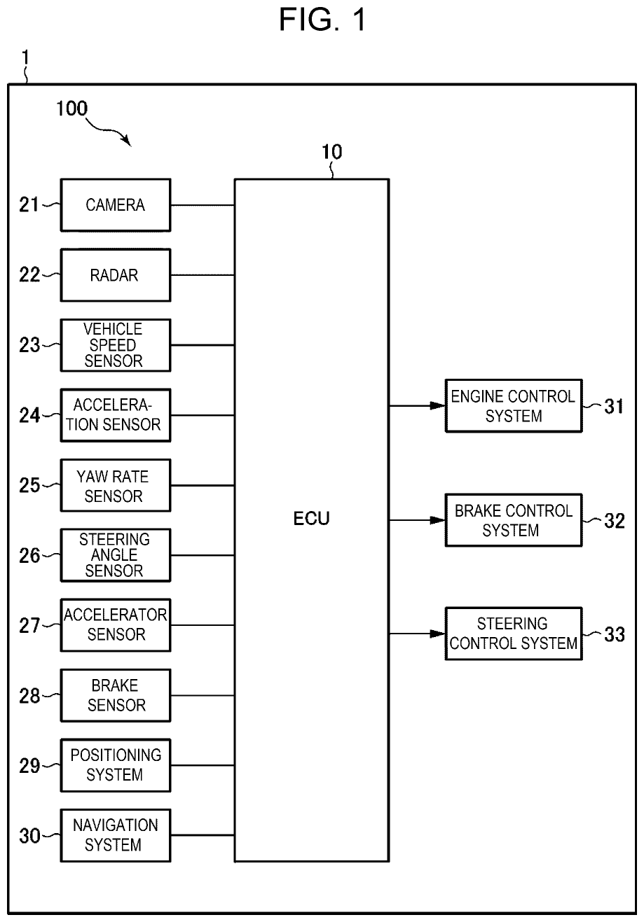

A description will firstly be made on a configuration of the vehicle driving assistance system according to the embodiment of the present disclosure with reference to FIG. 1. FIG. 1 is a block diagram illustrating a schematic configuration of the vehicle driving assistance system according to the embodiment of the present disclosure.

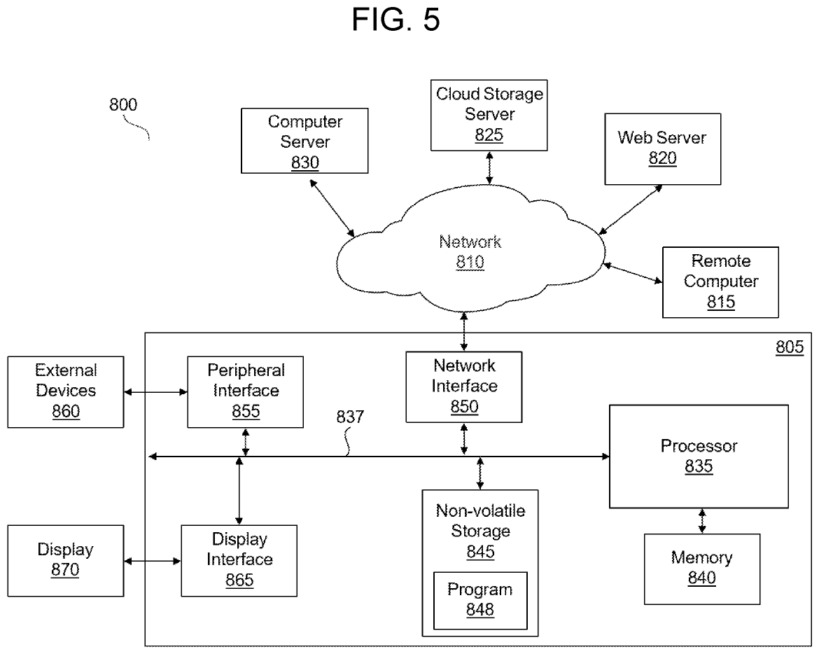

A vehicle driving assistance system 100 is configured to execute driving assistance control (automated driving control) for setting a target travel route for a vehicle 1 and causing the vehicle 1 to travel along this target travel route. As illustrated in FIG. 1, the vehicle driving assistance system 100 includes an electronic control unit (ECU) 10 as a vehicle controller or a controller, plural types of sensors, and plural control systems. Optionally, the ECU may include the processor 835 and other circuitry in system 800 of FIG. 5, which may be implemented as a single processor-based system, or a distributed processor based system, including remote processing, such as cloud based processing.

More specifically, the plural types of the sensors include a camera 21 (having an image sensor that takes fixed and/or moving images in the visual spectrum and/or non-visual ranges such as infrared and ultraviolet), a radar and/or Lidar 22 (short-range radars, SRR, that operate, for example, in the 20 GHz to 27 GHz range, long range radars, LRR, operating, for example, in the 76 to 81 GHz range, as well as Lidar that operates in at least one of ultraviolet, visible, and near infrared spectrums using lasers having a principle wavelength, for example, in a range of 500 nm to 1000 nm) a vehicle speed sensor 23 for detecting behavior of the vehicle 1 and a driving operation by an occupant, an acceleration sensor 24, a yaw rate sensor 25, a steering angle sensor 26, an accelerator sensor 27, and a brake sensor 28. Furthermore, the plural types of the sensors are a positioning system 29 for detecting a position of the vehicle 1 and a navigation system 30. The plural control systems are an engine control system 31, a brake control system 32, and a steering control system 33.

Moreover, other types of the sensors may be a peripheral sonar system for measuring a distance from and a position of a structure around the vehicle 1, a corner radar provided at each of four corners of the vehicle 1 to measure approach of the peripheral structure, and an inner camera for capturing an image of the inside of a vehicle cabin in the vehicle 1.

The ECU 10 executes various calculations on the basis of signals received from the plural types of the sensors, and sends control signals to the engine control system 31, the brake control system 32, and the steering control system 33 so as to appropriately actuate an engine system, a brake system, and a steering system, respectively. The ECU 10 is constructed of a computer that includes one or more processors (typically CPUs), memory (ROM, RAM, or the like) for storing various programs, an input/output device, and the like. The ECU 10 corresponds to an example of the “controller” in the present disclosure.

The camera 21 captures an image around the vehicle 1, and outputs image data. Based on the image data received from the camera 21, the ECU 10 identifies objects (for example, a preceding vehicle, a parked vehicle, a pedestrian, a travel road, road marking lines (a lane divider, a white line, and a yellow line), a traffic signal, a traffic sign, a stop line, an intersection, an obstacle, and the like). The ECU 10 may acquire information on the object from the outside through a traffic infrastructure, inter-vehicle communication, or the like. In this way, a type, a relative position, a moving direction, and the like of the object are identified.

The radar 22 measures a position and a speed of the object (particularly, the preceding vehicle, the parked vehicle, the pedestrian, a dropped object on a travel road 5, or the like). For example, a millimeter-wave radar can be used as the radar 22. The radar 22 transmits a radio wave in an advancing direction of the vehicle 1, and receives a reflected wave that is generated when the object reflects the transmitted wave. Then, based on the transmitted wave and the received wave, the radar 22 measures a distance between the vehicle 1 and the object (for example, an inter-vehicular distance) and a relative speed of the object to the vehicle 1. In this embodiment, instead of the radar 22, a laser radar, an ultrasonic sensor, or the like may be used to measure the distance from the object and the relative speed of the object. Alternatively, plural types of sensors may be used to constitute a position and speed measuring device.

The camera 21 and the radar 22 correspond to an example of the “travel road information acquisition device” in the present disclosure.

The vehicle speed sensor 23 detects an absolute speed of the vehicle 1. The acceleration sensor 24 detects acceleration of the vehicle 1, including a passenger compartment of the vehicle. This acceleration includes acceleration/deceleration in a longitudinal direction and acceleration/deceleration in a lateral direction. In the present specification, the “acceleration/deceleration” means both or one of a change rate of the speed in a speed increasing direction (that is, the acceleration) and a change rate of the speed in a speed reducing direction (that is, the deceleration). Example acceleration sensors employ a signal processor connected to a micromechanical comb structure that forms a capacitor with a capacitance set by the spatial distances between comb teeth. When subject to acceleration, relative displacement of comb teeth creates a capacitive change, which is sensed by the signal processor. Piezoelectric, piezoresistive and micro electro-mechanical system (MEMS) sensors may be used as well.

The yaw rate sensor 25 detects a yaw rate of the vehicle 1. The steering angle sensor 26 detects a rotation angle (a steering angle) of a steering wheel of the vehicle 1. The ECU 10 executes specified calculation on the basis of the absolute speed detected by the vehicle speed sensor 23 and the steering angle detected by the steering angle sensor 26, and can thereby acquire a yaw angle of the vehicle 1 (that is, an angle defined by the longitudinal direction of the vehicle 1 with respect to an x-axis, which will be described later). The accelerator sensor 27 detects a depression amount of an accelerator pedal. The brake sensor 28 detects a depression amount of a brake pedal.

The positioning system 29 is a GPS system and/or a gyroscopic system, and detects the position of the vehicle (current vehicle position information). The navigation system 30 stores map information therein, and can provide the map information to the ECU 10. Based on the map information and the current vehicle position information, the ECU 10 identifies a road, the intersection, the traffic signal, a building, and the like existing around (particularly, in the advancing direction of) the vehicle 1. The map information may be stored in the ECU 10. The navigation system 30 also corresponds to an example of the “travel road information acquisition device” in the present disclosure.

The engine control system 31 controls an engine of the vehicle 1. The engine control system 31 is a component capable of regulating engine output (drive power) and, for example, includes an ignition plug, a fuel injection valve, a throttle valve, a variable valve mechanism that changes opening/closing timing of intake/exhaust valves, and the like. When the vehicle 1 has to be accelerated or decelerated, the ECU 10 sends the control signal to the engine control system 31 so as to change the engine output.

The brake control system 32 controls a brake system of the vehicle 1. The brake control system 32 is a component capable of regulating a braking force of the brake system and, for example, includes a hydraulic pump, a valve unit, and the like. When the vehicle 1 has to be decelerated, the ECU 10 sends the control signal to the brake control system 32 so as to generate the braking force.

The steering control system 33 controls a steering device of the vehicle 1. The steering control system 33 is a component capable of regulating the steering angle of the vehicle 1 and, for example, includes an electric motor for an electric power steering system, and the like. When the advancing direction of the vehicle 1 has to be changed, the ECU 10 sends the control signal to the steering control system 33 so as to change a steering direction.

[Basic Concept of Driving Assistance]

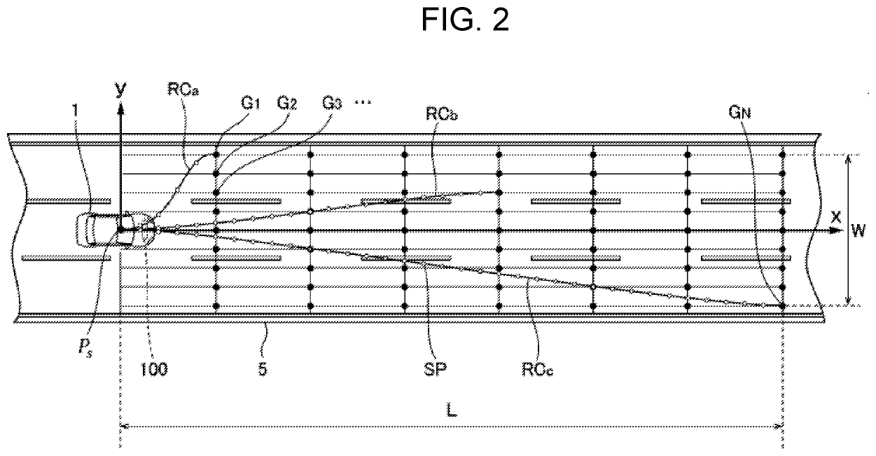

Next, a description will be made on basic concept of driving assistance that is executed by the above-described ECU 10 in the embodiment of the present disclosure with reference to FIG. 2. FIG. 2 illustrates a situation where the vehicle 1 travels on the travel road 5.

First, the ECU 10 executes the calculation to identify the position of the vehicle 1 on the travel road 5 on the basis of travel road information. The travel road information is information on the travel road 5 where the vehicle 1 travels, and is acquired by the camera 21, the radar 22, the navigation system 30, and the like. For example, the travel road information includes information on a shape of the travel road (a straight road, a curved road, curvature of the curved road), a travel road width, the number of lanes, a lane width, and the like.

Next, the ECU 10 executes the calculation based on the travel road information, so as to set plural virtual grid points Gₙ (n=1, 2, . . . N) on the travel road 5 existing ahead in the advancing direction of the vehicle 1. In the case where an extending direction of the travel road 5 is defined as an x-direction and a width direction of the travel road 5 is defined as a y-direction, the grid points Gₙ are arranged in a lattice shape along the x-direction and the y-direction. An origin of x-y coordinates is set to a point corresponding to the position of the vehicle 1.

An area where the ECU 10 sets the grid points Gₙ is stretched in front of the vehicle 1 for a distance L along the travel road 5. The distance L is calculated on the basis of the speed of the vehicle 1 at the time of the calculation. In this embodiment, the distance L is a distance for which the vehicle 1 is assumed to travel at a speed (V) during the calculation for a specified fixed time t (for example, three seconds) (L=V×t). However, the distance L may be a specified fixed distance (for example, 100 m) or a function of the speed (and the acceleration). In addition, a width W of the area where the grid points Gₙ are set is set to a substantially equal value to a width of the travel road 5. When the plural grid points Gₙ are set, just as described, the position of the vehicle 1 on the travel road 5 can be identified.

Here, the travel road 5 illustrated in FIG. 2 is a straight section, and thus the grid points Gₙ are arranged in a rectangular shape. However, the grid points Gₙ are arranged along the extending direction of the travel road. Thus, in the case where the travel road includes a curved section, the grid points Gn are arranged along curvature of the curved section. The road itself may be detected via visual discontinuities between the road surface and a different surface at the edge of the road, or perhaps by painted lines, reflectors, or other visual indicators on the road surface. Similar information is used for detecting a travel lane.

Next, based on the travel road information, the ECU 10 executes a calculation to set a travel route candidate RC (that is, a candidate that possibly becomes the target travel route where the vehicle 1 will actually travel). More specifically, the ECU 10 sets the plural travel route candidates RC by a route search using the state lattice method. In the state lattice method, the plural travel route candidates RC are initially set from the position of the vehicle 1 and disperse relative to one another in a branched manner toward the grid points Gₙ existing generally in the advancing direction of the vehicle 1. In FIG. 2, travel route candidates RCₐ, RC_{b}, RC_{c} are illustrated as some of the plural travel route candidates RC set by the ECU 10.

The ECU 10 may set the travel route candidates RC on the basis of obstacle information in addition to the travel road information. This obstacle information is information on presence or absence of the obstacle (for example, the preceding vehicle, the parked vehicle, the pedestrian, the dropped object, or the like) on the travel road 5 in the advancing direction of the vehicle 1, a moving direction thereof, a moving speed thereof, and the like, and is acquired by the camera 21 and the radar 22.

Next, as illustrated in FIG. 2, the ECU 10 sets plural sampling points SP along each of the travel route candidates RC, and calculates route cost at each of the sampling points SP. Each of these sampling points SP is a discrete point (position), which is provided on the route of each of the travel route candidates RC and at which the route cost is calculated. More specifically, for each of the plural travel route candidates RC, the ECU 10 calculates the route cost at each of the plural sampling points SP.

Next, based on the thus-calculated route cost of each of the plural travel route candidates RC, the ECU 10 selects a route with the minimum route cost from the plural travel route candidates RC, and sets such a route as the target travel route. Then, the ECU 10 sends the control signal to at least one of the engine control system 31, the brake control system 32, and the steering control system 33 such that the vehicle 1 travels along the set target travel route.

[Calculation of Route Cost]

Next, a description will be made on the route cost according to the embodiment of the present disclosure. Generally, the route cost includes a cost defined according to a combination of plural factors such as the speed, the acceleration/deceleration in the longitudinal direction, the acceleration/deceleration in the lateral direction, a route change rate, and the obstacle. This embodiment is characterized by the route cost that is defined according to the acceleration/deceleration in the longitudinal direction as one of plural types of such route cost. A specific description will hereinafter be made on this route cost according to the acceleration/deceleration in the longitudinal direction.

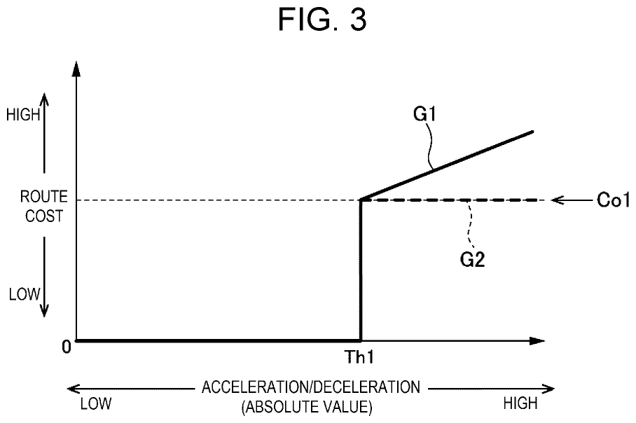

FIG. 3 is a map defining the route cost according to the embodiment of the present disclosure. In FIG. 3, a horizontal axis represents the acceleration/deceleration (the absolute value), and a vertical axis represents the route cost. In addition, a graph G1 indicated by a solid line represents a map of the route cost that is applied in this embodiment, and a graph G2 indicated by a broken line represents a map of the route cost that is applied in a comparative example. The ECU 10 refers to the map as illustrated in FIG. 3 to determine the route cost at the sampling point SP, for which the route cost should be calculated, on the travel route candidate RC according to the acceleration/deceleration generated at the sampling point SP.

In this embodiment, as indicated by the graph G1, in the case where the acceleration/deceleration is lower than a threshold Th1, the route cost is uniformly set to 0 (corresponding to a first specified value). That is, in the case where the acceleration/deceleration is lower than the threshold Th, the route cost is set to a constant value regardless of a magnitude of the acceleration/deceleration. This threshold Th1 is user-selectable and is defined on the basis of the acceleration/deceleration that can be accepted by a driver of the vehicle 1. For example, such a value that gives the driver a sense of discomfort at the time when the acceleration/deceleration exceeds this value is applied as the threshold Th1.

In this embodiment, in the case where the acceleration/deceleration is the threshold Th1, the route cost is set to a second specified value Co1 (a relatively high value as the route cost). In this case, when the acceleration/deceleration that is lower than the threshold Th1 reaches the threshold Th1, the route cost is increased stepwise from 0 to the second specified value Co1. In this way, the high route cost is applied to the travel route where the relatively high acceleration/deceleration is generated, which hinders setting of such a travel route.

In addition, in this embodiment, in the case where the acceleration/deceleration exceeds the threshold Th1, a value that is acquired by adding a value increased according to the magnitude of the acceleration/deceleration to the second specified value Co1 is set as the route cost. In particular, a value that is acquired by adding a value increased linearly as the acceleration/deceleration is increased to the second specified value Co1 is set as the route cost. A reason therefor will be described in comparison with the comparative example (the graph G2).

In the comparative example, as indicated by the graph G2, in the case where the acceleration/deceleration is equal to or higher than the threshold Th1, the route cost is uniformly set to the constant value (the second specified value Co1) regardless of the magnitude of the acceleration/deceleration. Also, in this comparative example, the high route cost is applied to the travel route where the relatively high acceleration/deceleration is generated, which hinders setting of such a travel route.

Here, in both of this embodiment and the comparative example, the route cost is set by applying the threshold Th1 of the acceleration/deceleration. Thus, generally, there is a tendency that the travel route where the acceleration/deceleration is relatively low is set. However, depending on a case, it is desired to set the travel route where the acceleration/deceleration is relatively high. An example of such a case is that the travel route is set in order to avoid the obstacle. In this case, it is expected that plural travel road candidates RC are provided for the travel route where the acceleration/deceleration is equal to or higher than the threshold Th1. Thus, the optimum travel route is preferably selected from such plural travel route candidates RC. Generally, of these plural travel route candidates RC, the travel route candidate with the lowest acceleration/deceleration can preferably be set.

However, in the comparative example, the route cost is set to the constant value in the case where the acceleration/deceleration is equal to or higher than the threshold Th1. Thus, the set route cost does not differ among the plural travel route candidates RC, on each of which the acceleration/deceleration is equal to or higher than the threshold Th1. Thus, in the comparative example, it is difficult to appropriately select the travel route to be applied from the plural travel route candidates RC, on each of which the acceleration/deceleration is equal to or higher than the threshold Th1, on the basis of the set route cost.

Meanwhile in this embodiment, as indicated by the graph G1, in the case where the acceleration/deceleration is equal to or higher than the threshold Th1, the route cost is set to the value that is increased according to the magnitude of the acceleration/deceleration. That is, in this embodiment, in the case where the acceleration/deceleration is equal to or higher than the threshold Th1, the route cost is not set to the constant value regardless of the magnitude of the acceleration/deceleration, but the route cost varies according to the magnitude of the acceleration/deceleration. According to this embodiment, just as described, the route cost appropriately differs among the plural travel route candidates RC, on each of which the acceleration/deceleration is equal to or higher than the threshold Th1. Thus, it is possible to select the optimum travel route from these plural travel route candidates RC. Typically, the travel route where the acceleration/deceleration is the lowest can appropriately be selected from the travel route candidates RC, on each of which the acceleration/deceleration is equal to or higher than the threshold Th1.

[Driving Assistance Processing]

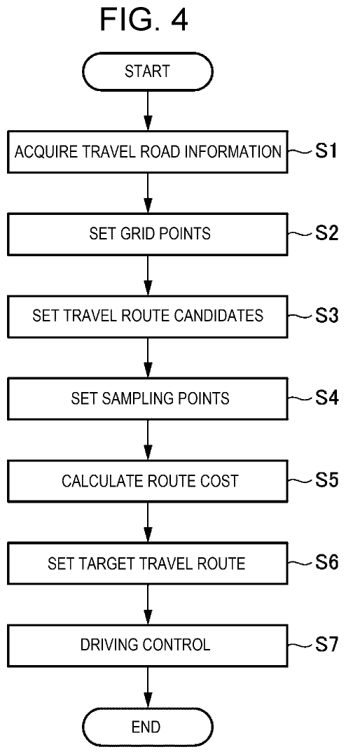

Next, FIG. 4 is a flowchart of driving assistance processing according to the embodiment of the present disclosure. This processing is repeatedly executed in specified cycles (for example, every 0.05 to 0.2 seconds) by the ECU 10.

First, in step S1, the ECU 10 acquires the travel road information from the camera 21, the radar 22, and the navigation system 30. Alternatively, or complimentarily, the travel road information may be obtained from other sources as well, such as Lidar, and from radio frequency (RF) communication messages received by a RF receiver and the RF messages sent from external devices such as other cars, which have other sensors, as well as beacons, which are local devices that transmit absolute position data of SPs on the travel road in that particular location.

Next, in step S2, the ECU 10 identifies the shape of the travel road 5 (for example, the extending direction of the travel road 5, the width of the travel road 5, and the like) on the basis of the travel road information, and sets the plural grid points Gₙ (n=1, 2, . . . N) on the travel road 5. For example, the ECU 10 sets the grid point Gₙ for every 10 m in the x-direction and every 0.875 m in the y-direction.

Next, in step S3, the ECU 10 sets the plural travel route candidates RC by the route search using the state lattice method on the basis of the travel road information. More specifically, the ECU 10 sets the plural travel route candidates RC in the manner to be branched from the position of the vehicle 1 toward the grid points Gₙ existing in the advancing direction of the vehicle 1. The ECU 10 may set the travel route candidates RC on the basis of the obstacle information in addition to the travel road information. Moreover, lattice-based graphs are constructed by applying a set of motion primitives to each state expanded during the search in order to generate valid successor states. By doing this, they generate edges in the search graph between the (possibly non-adjacent) discretized states which serve as the graph nodes. A graph search algorithm, such as A* act on this lattice to generate a trajectory as a sequence of motion primitives between the start and goal state. As a type of graph, a state lattice has a set of states, S, connected by edges, E. To construct the set of states, S, each dimension is discretized into cells of finite size. Typically, metric dimensions are divided into small grids, for example, 0.1 m square regions, or as angular dimensions, e.g. {0°, 45°, . . . , 315°}. Larger cells, and therefore fewer states, improves planning speed, while smaller cells can more accurately represent the environment but require more processing power. State lattices for vehicle movement also may include curvature, velocity, or other state variables as well. An example set is (x, y, yaw, vel). Edges of the state lattice are constructed by applying a set of pre-computed motion primitives to each state s ∈ S and then adding a directed edge from s to the state s′ ∈ S at which the motion primitive ends. The motion primitives can be generated in a number of different ways. Example motion primitives are optionally generated off-line and stored as a library or via a control signal applied for a short time, where the trajectory resulting from this control input is the motion primitive. In an exemplary embodiment, motion primitives for stored in advance for left and right hand lane changes.

Next, in step S4, the ECU 10 sets the plural sampling points SP along each of the travel route candidates RC. For example, on each route of the travel route candidates RC, the ECU 10 sets the sampling points SP at equally-spaced intervals (every 0.2 m in an example) in the x-direction.

Next, in step S5, the ECU 10 calculates the route cost of each of the plural travel route candidates RC. More specifically, for each of the plural travel route candidates RC, the ECU 10 calculates the route cost at each of the plural sampling points SP. Then, the ECU 10 calculates the route cost, which is applied to the travel route candidate RC, from the plural types of the route cost that are calculated at the plural sampling points SP in the single travel route candidate RC. For example, the ECU 10 sets an average value of the plural types of the route cost at the plural sampling points SP as the route cost of the single travel route candidate RC. In this way, the ECU 10 calculates the route cost of all of the plural travel route candidates RC.

More specifically, when calculating the route cost at each of the sampling points SP, the ECU 10 calculates the plural types of the route cost, such as the route cost that is defined according to the speed, the route cost that is defined according to the acceleration/deceleration in the longitudinal direction, the route cost that is defined according to the acceleration/deceleration in the lateral direction, the route cost that is defined according to the route change rate, and the route cost that is defined according to the obstacle. Then, the ECU 10 calculates the route cost, which is finally applied at each of the sampling points SP, by weighing each of the thus-acquired plural types of the route cost, for example.

In particular, in this embodiment, in the case where the ECU 10 calculates the route cost on the basis of the acceleration/deceleration in the longitudinal direction, the ECU 10 refers to the map illustrated in FIG. 3 to calculate the route cost. In detail, in regard to the sampling point as a target, for which the route cost is calculated, the ECU 10 uses a specified model, a calculation formula, and the like to calculate the acceleration/deceleration in the longitudinal direction that is generated at the time when the vehicle 1 passes the sampling point SP, and sets the route cost according to this acceleration/deceleration. In the case where the acceleration/deceleration (the absolute value) is lower than the threshold Th1, the ECU 10 sets the route cost to 0. In the case where the acceleration/deceleration is the threshold Th1, the ECU 10 sets the route cost to the second specified value Co1. In the case where the acceleration/deceleration exceeds the threshold Th1, the ECU 10 sets the value, which is acquired by adding the value increased linearly according to the magnitude of the acceleration/deceleration to the second specified value Co1, as the route cost (see FIG. 3).

Next, in step S6, the ECU 10 sets the target travel route. More specifically, the ECU 10 selects the route with the minimum route cost from the plural travel route candidates RC on the basis of the route cost of each of the plural travel route candidates RC calculated as described above, and sets such a route as the target travel route.

Next, in step S7, the ECU 10 executes driving control (vehicle behavior control) including speed control and/or steering control of the vehicle 1 such that the vehicle 1 travels along the target travel route. More specifically, the ECU 10 sends the control signal to at least one of the engine control system 31, the brake control system 32, and the steering control system 33 and executes at least one of the engine control, braking control, and the steering control.

FIG. 5 illustrates a block diagram of a computer that may implement the various embodiments described herein. The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 5 is a functional block diagram illustrating a networked system 800 of one or more networked computers and servers. In an embodiment, the hardware and software environment illustrated in FIG. 5 may provide an exemplary platform for implementation of the software and/or methods according to the present disclosure.

Referring to FIG. 5, a networked system 800 may include, but is not limited to, computer 805, network 810, remote computer 815, web server 820, cloud storage server 825 and computer server 830. In some embodiments, multiple instances of one or more of the functional blocks illustrated in FIG. 5 may be employed.

Additional detail of computer 805 is shown in FIG. 5. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810. Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip GPUs, CPUs, or microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like. Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860. An example of an external device 860 is a radio frequency (RF) device that conveys RF messages of travel road data or obstacle data.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

[Operation and Effects]

Next, a description will be made on an operation and effects according to the embodiment of the present disclosure.

In this embodiment, in the vehicle driving assistance system 100 that sets the plural travel route candidates RC on the basis of the travel road information acquired from the camera 21 and the like, calculates the route cost for each of these plural travel route candidates RC, and sets the target travel route from the plural travel route candidates RC on the basis of this route cost, the ECU 10 (1) sets the route cost to the first specified constant value in the case where the acceleration/deceleration (the absolute value) that is generated in the longitudinal direction at the time when the vehicle 1 travels on the travel route candidate RC is lower than the threshold Th1, (2) sets the route cost to the second specified value Co1 that is higher than the first specified value in the case where the acceleration/deceleration is the threshold Th1, and (3) sets the route cost to the value that is acquired by adding the value increased according to the magnitude of the acceleration/deceleration to the second specified value Co1 in the case where the acceleration/deceleration exceeds the threshold Th1.

In this embodiment, just as described, in the case where the acceleration/deceleration is equal to or higher than the threshold Th1, the route cost is set to the value that is increased according to the magnitude of the acceleration/deceleration. That is, in this embodiment, in the case where the acceleration/deceleration is equal to or higher than the threshold Th1, the route cost is not set to the constant value regardless of the magnitude of the acceleration/deceleration, but the route cost varies according to the magnitude of the acceleration/deceleration. As a result, the route cost appropriately differs among the plural travel route candidates RC, on each of which the acceleration/deceleration is equal to or higher than the threshold Th1. Thus, it is possible to select the optimum travel route from these plural travel route candidates RC. Typically, it is possible to appropriately select the travel route with the lowest acceleration/deceleration from the travel route candidates RC, on each of which the acceleration/deceleration is equal to or higher than the threshold Th1.

In addition, in this embodiment, in the case where the acceleration/deceleration exceeds the threshold Th1, the ECU sets the route cost by adding the value, which is increased linearly as the acceleration/deceleration is increased, to the second specified value Co1. In this way, the route cost can reliably differ among the plural travel route candidates RC, on each of which the acceleration/deceleration is equal to or higher than the threshold Th1.

In this embodiment, the threshold Th1 is defined on the basis of the magnitude of the acceleration/deceleration that can be accepted by the driver of the vehicle 1. Accordingly, the high route cost is applied to the travel route where the acceleration/deceleration that is equal to or higher than this threshold T1 is generated, and setting of such a travel route is hindered. In this way, it is possible to suppress the driver from receiving the sense of discomfort caused by the acceleration/deceleration.

In this embodiment, the first specified value is applied with 0. That is, the route cost related to the acceleration/deceleration is not substantially applied to the travel route where the acceleration/deceleration is lower than the threshold Th1. Thus, it is possible to preferentially set the travel route where the acceleration/deceleration is lower than the threshold Th1.

### MODIFIED EXAMPLES

In the above-described embodiment, the first specified value is applied with 0. However, the first specified value is not limited to being applied with 0. That is, a value that is at least lower than the second specified value Co1, in particular, a value that is much lower than the second specified value Co1 is preferably set as the first specified value. Thus, the first specified value is not limited to being set to 0.

In addition, in the above-described embodiment, an example in which the present disclosure is applied to the vehicle 1 having the engine as a drive source has been described (see FIG. 1). However, the present disclosure can also be applied to a vehicle having an electric motor as the drive source (an electric vehicle or a hybrid vehicle). Furthermore, in the above-described embodiment, the braking force is applied to the vehicle 1 by the brake system (the brake control system 32). However, in another example, the braking force may be applied to the vehicle by regeneration of the electric motor.

### DESCRIPTION OF REFERENCE SIGNS AND NUMERALS

1: Vehicle

5: Travel road

10: ECU

21: Camera

22: Radar

30: Navigation System

100: Vehicle driving assistance system

800: Networked system

805: Computer

810: Network

815: Remote computer

820: Web Server

825: Cloud storage server

830: Computer server

835: Processor

837: Bus

840: Memory

845: Non-volatile storage

848: Program

850: Network interface (wireless)

855: Peripheral Interface

860: External devices

865: Display interface

870: Display

Gₙ: Grid point

RC: Route candidate

SP: Sampling point

1. A vehicle driving assistance system comprising:
a travel road information acquisition interface that acquires travel road information about a travel road on which a vehicle is located, the interface configured to obtain the travel road information from any combination of a sensor, a set of sensors, and a remote source; and
a controller having circuitry configured to set a target travel route for the vehicle in the travel road based on the travel road information and to execute driving control of the vehicle so the vehicle travels along the target travel route, wherein
the circuitry is configured to:
set plural travel route candidates as candidate options for setting the target travel route based on the travel road information;
calculate route cost for each of the plural travel route candidates; and
select one travel route of the plural travel route candidates as the target travel route on the basis of having a lowest route cost, and
the circuitry is further configured to:
under a condition where a magnitude of acceleration/deceleration that is generated in a longitudinal direction of vehicle movement on the travel route candidate is lower than a specified threshold, set the route cost to a first specified constant value,
under a condition where the magnitude of the acceleration/deceleration is the specified threshold, set the route cost to a second specified value that is higher than the first specified value, and
under a condition where the magnitude of the acceleration/deceleration exceeds the specified threshold, set the route cost to an aggregate value that is a summation result of a value that increases with the magnitude of the acceleration/deceleration and the second specified value.

2. The vehicle driving assistance system according to claim 1, wherein
under the condition where the magnitude of the acceleration/deceleration exceeds the specified threshold, the circuitry is configured to set the value that increases with the magnitude of the acceleration/deceleration to increase linearly with vehicle acceleration/deceleration.

3. The vehicle driving assistance system according to claim 1, wherein
the specified threshold is a user-settable parameter.

4. The vehicle driving assistance system according to claim 1, wherein
the first specified value is 0.

5. The vehicle driving assistance system according to claim 1, wherein
the circuitry is configured to set plural sampling points on each of the plural travel route candidates, and set a corresponding route cost at each of the sampling points based on the magnitude of the acceleration/deceleration.

6. The vehicle driving assistance system according to claim 1, wherein
the travel road information acquisition interface includes the set of sensors, the set of sensors including at least one of a camera, a radar, and a Lidar.

7. The vehicle driving assistance system according to claim 1, wherein
the travel road information acquisition interface includes a RF receiver that receives the travel road information from the remote source via RF communications.

8. The vehicle driving assistance system according to claim 1, further comprising:
an accelerometer that detects an acceleration/deceleration experience by a passenger compartment of the vehicle.

9. A vehicle driving assistance method executed by a controller including a computer, the vehicle driving assistance method comprising:
setting, with circuitry, plural travel route candidates as candidate options for setting a target travel route for a vehicle located on a travel road based on travel road information on the travel road;
calculating, with the circuitry, route cost for each of the plural travel route candidates;
selecting one travel route of the plural travel route candidates as the target travel route having a lowest route cost; and
executing driving control of the vehicle so the vehicle travels along the target travel route, wherein
the calculating includes
under a condition where a magnitude of acceleration/deceleration that is generated in a longitudinal direction of vehicle movement on the travel route candidate is lower than a specified threshold, setting route cost to a first specified constant value;
under a condition where the magnitude of the acceleration/deceleration is the threshold, setting the route cost to a second specified value that is higher than the first specified value; and
under a condition where the magnitude of the acceleration/deceleration exceeds the threshold, setting the route cost to an aggregate value that is a summation result of a value that increases with the magnitude of the acceleration/deceleration and the second specified value.

10. The vehicle driving assistance method according to claim 9, wherein
under the condition where the magnitude of the acceleration/deceleration exceeds the specified threshold, the setting the route cost to the aggregate value includes setting the value that increases with the magnitude of the acceleration/deceleration to increase linearly with vehicle acceleration/deceleration.

11. The vehicle driving assistance method according to claim 9 wherein
the specified threshold is a user-settable parameter.

12. The vehicle driving assistance method according to claim 9, wherein
the first specified value is 0.

13. The vehicle driving assistance method according to claim 9, further comprising:
setting plural sampling points on each of the plural travel route candidates, and setting a corresponding route cost at each of the sampling points based on the magnitude of the acceleration/deceleration.

14. The vehicle driving assistance method according to claim 9, wherein
the travel road information acquisition interface includes the set of sensors, the set of sensors including at least one of a camera, a radar, and a Lidar.

15. The vehicle driving assistance method according to claim 9, wherein
the travel road information acquisition interface includes a RF receiver that receives the travel road information from the remote source via RF communications.

16. The vehicle driving assistance method according to claim 9, further comprising:
detecting with an accelerometer an acceleration/deceleration experienced by a passenger compartment of the vehicle.

17. A non-transitory computer readable storage device having computer readable instructions that when executed by a controller, which includes a computer, cause the computer to execute a vehicle driving assistance method, the vehicle driving assistance method comprising:
setting, with circuitry, plural travel route candidates as candidate options for setting a target travel route for a vehicle located on a travel road based on travel road information on the travel road;
calculating, with the circuitry, route cost for each of the plural travel route candidates;
selecting one travel route of the plural travel route candidates as the target travel route having a lowest route cost; and
executing driving control of the vehicle so the vehicle travels along the target travel route, wherein
the calculating includes
under a condition where a magnitude of acceleration/deceleration that is generated in a longitudinal direction of vehicle movement on the travel route candidate is lower than a specified threshold, setting route cost to a first specified constant value;
under a condition where the magnitude of the acceleration/deceleration is the threshold, setting the route cost to a second specified value that is higher than the first specified value; and
under a condition where the magnitude of the acceleration/deceleration exceeds the threshold, setting the route cost to an aggregate value that is a summation result of a value that increases with the magnitude of the acceleration/deceleration and the second specified value.

18. The non-transitory computer readable storage device according to claim 17, wherein
under the condition where the magnitude of the acceleration/deceleration exceeds the specified threshold, the setting the route cost to the aggregate value includes setting the value that increases with the magnitude of the acceleration/deceleration to increase linearly with vehicle acceleration/deceleration.

19. The non-transitory computer readable storage device according to claim 17, wherein
the specified threshold is a user-settable parameter.

20. The non-transitory computer readable storage device according to claim 17, wherein
the first specified value is 0.
